(19) United States
(12) Patent Application Publication
(10) Pub. No.: US 2015/0224502 A1
(43) Pub. Date: Aug. 13, 2015

(54) Flow-through cartridge-based system for collecting and processing samples from water

(71) Applicant: Monterey Bay Aquarium Research Institute, Moss Landing, CA (US)

(72) Inventors: Douglas Pargett, Mountain View, CA (US); Scott Jensen, San Martin, CA (US); Christina Preston, Monterey, CA (US); David Boone, San Jose, CA (US); Bryant Grigsby, Los Gatos, CA (US)

(21) Appl. No.: 14/620,739

(22) Filed: Feb. 12, 2015

Related U.S. Application Data
(60) Provisional application No. 61/938,882, filed on Feb. 12, 2014.

(51) Int. Cl. B01L 3/00

(52) U.S. Cl. CPC B01L 3/567; B01L 3/502; B01L 3/527; B01L 2400/0622; B01L 2400/0694

(57) ABSTRACT

A compact flow-through water collection and processing device includes a configurable fluidic path through multiple flow-through sampling cartridges connected to a distribution valve ring. Simultaneous parallel and/or serial flow paths may be controllably selected, allowing the cartridges in the flow paths to collect material suspended or dissolved in the water flowing through the flow path.

### CROSS-REFERENCE TO RELATED APPLICATIONS

This application claims priority from U.S. Provisional Patent Application 61/938,882 filed Feb. 12, 2014, which is incorporated herein by reference.

### STATEMENT OF GOVERNMENT SPONSORED SUPPORT

This invention was made with Government support under grant (or contract) no. OCE-0962032 awarded by the National Science Foundation. The Government has certain rights in the invention.

### FIELD OF THE INVENTION

The invention relates generally to the field of environmental water sampling and analysis. More specifically, it relates to methods and devices for autonomous, remote collection and processing of samples from water.

### BACKGROUND OF THE INVENTION

Understanding the presence, abundance, distribution, and population dynamics of microorganisms as well as natural or man-made substances that occur in aquatic environments demands frequent collection of discrete water samples at many locations and in some cases at various depths. Timely handling of that material to reveal biological or chemical “targets” of interest is often needed for conducting basic research, managing wildlife and natural resources, and for protecting public health. In many cases, sample-handling requirements dictate the use of laboratory facilities that are not easily transportable to remote field sites, or that require substantial effort to use outside of a traditional laboratory setting. In addition, the organisms or substances of interest in the environment, or in industrial product streams may be dilute and exist in complex matrices that can interfere with downstream testing. For that reason, bulk water sample collection, which stores the water and target materials at the same concentration as existed in the environment or process, is often followed in the lab by procedures to purify and concentrate the targets of interest prior to testing. The need for prompt, human-mediated handling of collected samples contributes both to the expense and time-to-result of many monitoring and testing schemes.

Repeated acquisition of samples from multiple locations and over extended periods of time, coupled with the need for a quick return of samples to a lab for testing, severely hampers our ability to generate synoptic and timely pictures of the distribution, abundance and trajectory of biological or chemical materials in an environment. This problem is further exacerbated in cases of dynamic environments where the occurrence and concentration of targeted substances may vary greatly both spatially and temporally. In such instances, a distributed array of sampling stations is needed to synoptically capture snapshots of the location and movement of particular targets since it is not always possible to know where exactly they may be at any given time within a given area.

In sharp contrast, many traditional physical and standard chemical properties of the water column or industrial product streams may be determined in real-time at high frequency using a variety of widely available sensor systems (e.g., for temperature, pressure, conductivity, pH, optical properties, etc.). Consequently there is an enormous disparity between the effort required to gather and interpret these common physical and chemical measurements versus the time and labor needed to synchronously identify and enumerate particular target organisms or chemical substances within an appropriate environmental context.

Molecular probe technologies (e.g., DNA, RNA, peptic nucleic acid, lectin, receptor or antibody-based) and modern chemical analyzers (e.g., chromatographic or mass-based) offer one means to speed and ease the detection and quantification of an enormous variety of organisms and chemical substances. However, as noted above, such applications rest largely on returning samples to specialized laboratories for analytical schemes that demand trained personnel to execute. These requirements severely restrict the utilization of modern molecular analytical and chemical testing because the rate of sample processing is inherently limited and application of the technology outside of a laboratory setting is difficult, impractical, or impossible. U.S. Pat. Nos. 6,187,530 and 7,674,581, which are hereby incorporated by reference, disclose aquatic autosampler devices that are capable of real-time sample processing using molecular probe methodologies. However, both of the above cited patents are integrated systems that do not support a wide variety of biological and chemical analyses following sample collection. In addition, the exact sequence of sample collection and corresponding analytical events are fixed when each device is fielded.

The existing systems provide only some elements of what is needed to begin correlating molecular-based assays with sensors that measure standard chemical and physical properties of aqueous environments. They are far too large, complex, cumbersome and power consumptive to be widely deployable in a variety of environments and for a variety of purposes. Novel instrumentation is therefore required to meet the needs of researchers, resource managers, and public health officials who need access to real-time information concerning the distribution and abundance of microorganisms or substances in dynamic environmental and industrial settings.

### SUMMARY OF THE INVENTION

In one aspect, the present invention provides a cartridge-based device that combines generic sample acquisition capability with a modular cartridge system for concentrating particles or dissolved substances. The material acquired can be preserved for later analyses, or processed for immediate analysis in situ given a choice of downstream detection technologies. In addition to being compact and easy to use, the instrument package is highly portable, rugged, capable of remote and autonomous operation on mobile and fixed platforms, and has a modularity that allows a seamless coupling of “front end” sample collection and handling ability with a suite of different “back end” analytical devices. To the best of our knowledge, instrumentation of this class does not exist in the prior art.

This invention relates to a portable, battery operated, field deployable, autonomous device that concentrates particles and dissolved substances from liquids at pressures up to 450 psi, or when submerged up to 300 meters depth. Particulate and/or dissolved material is collected using filtration or a chemically active sorbent. After collection, the device can either preserve that material for later laboratory-based analyses, or condition it for immediate analysis in situ using a variety of molecular biological and chemical analytical technologies. This instrument is suitable for extended use outside of a laboratory setting, and is accessible via wired or wireless connection. It has a wide range of applications, such as monitoring marine or freshwater environments, agriculture sites, and industrial product streams. Its utility is further enhanced because it can be deployed in a network configuration to enable assessments of biological and chemical properties over extended geographic areas absent direct human intervention.

In one aspect, the invention provides a device that uses a series of cartridges for collecting and processing individual samples of particulate and/or dissolved materials collected using filtration or a chemically active sorbent from source water flowing through the cartridge. The cartridges connect to and are actuated by a single core instrument via standard interfaces. This design provides consistent and uniform connection of power, fluidics, and communications between the instrument driver and cartridges, allowing use of a variety of cartridges for carrying out different processes that may be incompatible on integrated-style instruments. The device uses flow-through sampling, i.e., only the retentate materials stay in the cartridges and the system returns the bulk of the filtrate to the environment or process. This system can concentrate retentate materials from water volumes much greater than the size of the instrument, enabling the detection of rare targets not detectable by bulk water samplers of similar size.

In another aspect, the invention provides a device that uses a common flow loop that supplies source fluid to any cartridge or multiple cartridges at any given time. Existing systems can collect only single samples at a time for preserving or processing. In contrast, this device can provide the source fluid to any cartridge, even multiple cartridges in parallel simultaneously. Additionally, this flow loop can direct the source fluid though multiple cartridges in series, such that the filtrate returned from one cartridge is supplied to another cartridge. Combinations of parallel and series flow through multiple cartridges is also possible. This unique capability enables the collection and processing of multiple retentate samples that are both time and location coincident.

In another aspect, the invention provides a device that has modular assemblies that allow for disposable or reusable cartridges to have multiple functions depending on the components required. The modularity stems from an overall common cartridge form factor that is derived by assembling a series of interchangeable parts; the combination of sub-assemblies employed confers specific sample material collection and handling capabilities. This cartridge configurability allows users to meet the needs associated with a wide range of applications given a common, “backbone” core instrument. Moreover, each cartridge carries only the components necessary for the process it will execute, saving space, weight and power that is allocable to other cartridges that may also be needed for a given operation.

In another aspect, the invention provides a device that has a consistent and uniform connection between sampling cartridges and downstream analytical instruments. This connection allows for products exiting a cartridge to be passed to any number of optional modules attached to the instrument for real-time detection of targets, or to meet specialized processing requirements that cannot be met by the cartridges alone. This modularity allows deployment hardware to be tailored specifically to meet the requirements of many different use case scenarios, and enables use of a wide array of “back end” detection processes and systems.

In another aspect, the invention provides a device that has small physical size to improve portability. Compared to the size of existing automated sample collection and processing systems, this device is much smaller and can be hand-carried to remote field sites. The scale of this system also allows it be operated as a payload on mobile underwater vehicles, enabling new modes of water sample collection and processing that involve dynamic positioning within a large volume. Its small size also makes it more economical to operate on moorings, freely drifting platforms, or to connect to product streams since it does not require expensive and complex deployment infrastructure as do the existing, integrated sample collection and analytical systems.

A flow-through water collection and processing device according to the invention includes an intake valve configured to controllably allow water to flow into the device from an environment external to the device, an exhaust valve configured to controllably allow water to flow out of the device into the environment, a fluidic path through the instrument from the intake valve to the exhaust valve, a pumping system configured to pump water through the fluidic path, a central ring of distribution valves configured to controllably select simultaneous parallel flow paths of the fluidic path, and multiple removable flow-through sampling cartridges positioned in the simultaneous parallel flow paths and configured to allow water flowing through the flow paths to flow through the cartridges. Each of the cartridges has an input port, an output port, a cartridge flow path from the input port to the output port, and a sample collection medium configured to collect material suspended or dissolved in the water flowing through the flow path. The device also includes control electronics configured to turn on and off the pumping system, and to open and close the intake valve, exhaust valve, and distribution valves.

Two or more of the multiple sampling cartridges may be positioned in at least one of the simultaneous parallel flow paths, so that water flows in series through the two or more of the multiple sampling cartridges. The device may include a rotatable cartridge wheel configured to hold the cartridges, and a motor configured to rotate the wheel. It may include an analytical module configured to process the material collected in at least one of the cartridges. The water collection and processing device may include a cartridge product hand-off system configured to deliver collected material from one of the sampling cartridges to the analytical module. It may include an electronic bus configured to make electrical contact with cartridges. Each cartridge preferably has on-board electronics, processing reagents, heater, fluid reservoirs, fluid manipulators, flow management elements, and sensors. The on-board electronics may be configured to store information that identifies the cartridge, to provide processing instructions, and to record a processing log. Each cartridge may have a cartridge product treatment module configured to perform material processing.

### BRIEF DESCRIPTION OF THE DRAWINGS

FIGS. 1A, 1B, 1C are schematic diagrams illustrating case scenarios for integrated sample collection and processing by a device according to embodiments of the present invention.

FIG. 2 is a cross-sectional illustration of an embodiment of a portable, cartridge based device for particle collection and processing implemented as a payload instrument integrated onto an autonomous underwater vehicle (AUV) according to an embodiment of the invention.

FIG. 3 is a view of a sampling cartridge with two cartridge product treatment modules, on-board electronics, reagents, and sample concentration media according to an embodiment of the invention.

FIGS. 4A, 4B are schematic representations of serial and parallel flow paths, respectively, made possible by a central ring of distribution valves in a device according to an embodiment of the present invention.

FIG. 5 is an internal view of a device with one cartridge in the cartridge processing position, and multiple cartridges exploded from the central ring of distribution valves, according to an embodiment of the invention.

FIG. 6 is a cross-sectional view of a sampling cartridge with cartridge valve in the sampling position, showing a representative fluidic scheme, and layout of the sample collection media holder, cartridge valve, and input/output ports, according to an embodiment of the invention.

FIG. 7A is a view illustrating details of the connection between a sampling cartridge and a central ring of distribution valves according to an embodiment of the invention.

FIG. 7B is a perspective view of a collection media holder according to an embodiment of the invention.

FIG. 8 is a cross-sectional view of a sampling cartridge with cartridge valve in the reagent position showing fluid paths to/from reagent reservoirs according to an embodiment of the invention.

### DETAILED DESCRIPTION

A device according to an embodiment of the present invention is designed to collect particulates and other substances from a water source or industrial process-flow stream. The materials collected can be stored onboard the device, preserved for later analyses, or processed immediately within the instrument using physical, chemical, and/or biological means to liberate target molecules and facilitate downstream detection. Immediate processing of the sample is accomplished using a separate, swappable suite of instruments referred to here as “analytical modules”; multiple analytical modules may be attached to the sample collection and processing device at any time using a standardized interface. Analytical modules are used to detect and quantify target organisms and/or substances in situ, in real-time.

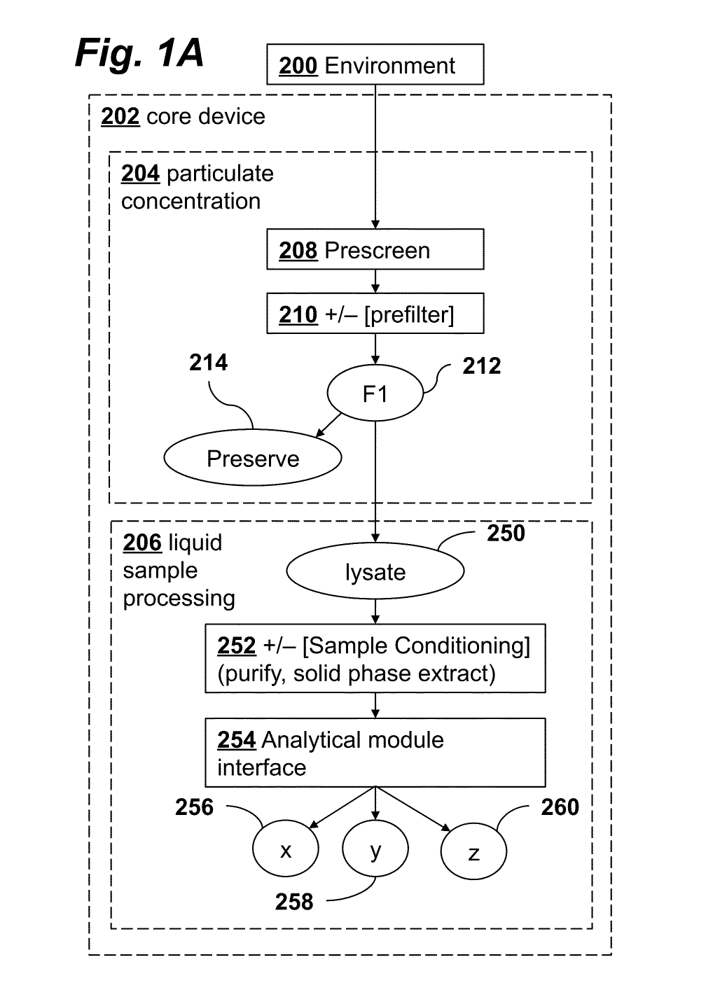

Examples that illustrate a variety of sample collection and handling schemes using this device are schematized in FIGS. 1A, 1B, 1C. In these scenarios, liquids from the environment 200 enter the core device 202 which includes a particulate concentration subsystem 204 connected to a liquid sample processing subsystem 206. In the particulate concentration subsystem 204 the liquid is prescreened 208 and prefiltered 210 upstream of the sampler to remove large debris. Once fluids enter the system, they may or may not be treated further prior to being passed through the primary collection media. In the scenario of FIG. 1A, one filter is used to either preserve collected solids 214 or create a lysate 250 which is then processed. Specifically, the target organisms or substances are concentrated on collection media 212 (F1), and then can be preserved 214, or liberated as a lysate 250 for further analysis using downstream analytical modules in subsystem 206. The lysate is conditioned 252 (e.g., purification and extraction of solid phase) and the products are processed by analytical module interface 254 to analytical modules 256 (x), 258 (y) and 260 (z) that perform downstream analysis (e.g., qPCR, microarray). Scenario of FIG. 1B shows a sampling configuration where liquid entering the device is split evenly and sent into parallel flows, which allows for collection of more material and to collect identical samples where each may require a different homogenization protocol. Target molecules are removed from the flows in parallel (two or more replicates) by collection media 216 (F1a) and 218 (F1b) for either preservation 220 and/or further downstream analyses. Specifically, lysate 262 liberated from 216 and lysate 264 from 218 pass through conditioning 252, analytical module interface 254, to analytical modules 256, 258, 260, just as in scenario of FIG. 1A. There is also the option to process and analyze filtrate 266 from 218 as well to capture substances not removed at the primary collection stage. Scenario of FIG. 1C shows a sequential sample concentration scenario, where target molecules from different subsamples can be liberated and analyzed separately. This allows for size fractionation. The flow passes through collection media 222 (F1) and then through collection media 224 (F2). Preserve 226 can be retained from either or both of 222 and 224. Alternatively, the collected material can be liberated as lysates 268 and 272 from media 224 and 222, respectively. This scenario also allows for analysis of filtrate 270. Subsequent conditioning 252, processing by analytical module interface 254, and analytical modules 256, 258, 260 is the same as in the other cases. These example use cases are just three of the many possible configurations possible using the cartridge-based design for autonomous operation in situ, with the sample system either residing freely in the environment of interest, or at a fixed location with a fluidic connection to the environment/product stream of interest. The prefilter and sample conditioning steps may be absent in some embodiments.

Typically, autonomous in situ water samplers used for environmental testing and monitoring purposes are large and bulky, and generally require a ship with significant crane capacity to deploy and recover. Here we describe an autonomous water sample collection and processing device of significantly reduced size, e.g., it may be realized as a device with roughly the dimensions of 11.5″ in diameter and 24″ in length. This size makes the device hand-portable, as well as easily mountable on a variety of platforms (e.g., on piers or moorings, in suitcases, and as payloads for underwater vehicles).

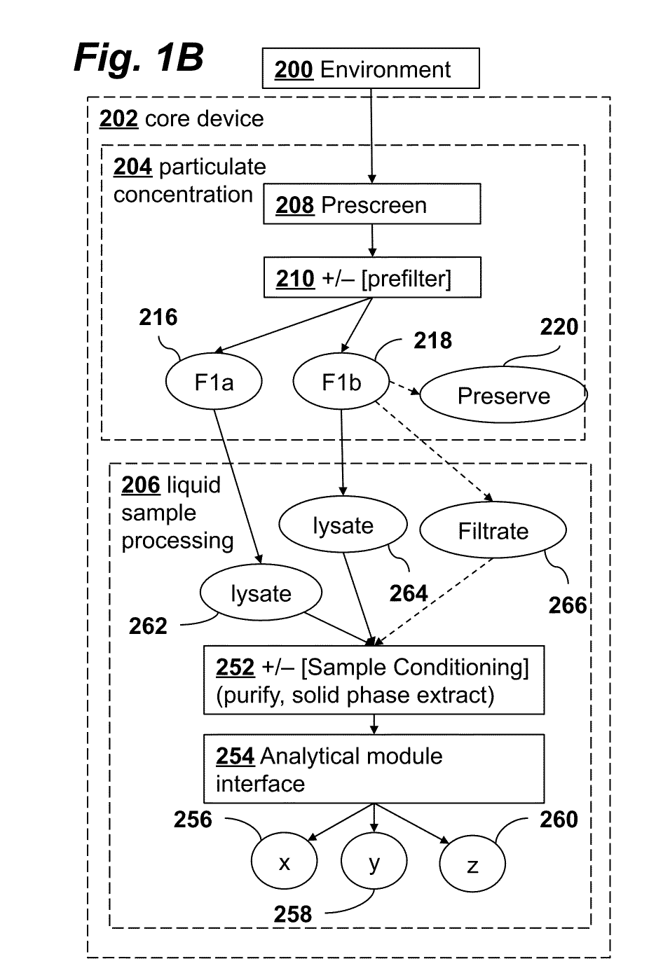

In the embodiment shown in FIG. 2, the device is designed to operate outside of a laboratory environment autonomously and at a remote field site, and can be mounted on a mobile platform. The source fluid path and filtering system can withstand pressures up to 450 psi. When encased in an appropriate pressure housing 20 with an external sampling port 22, the instrument can be submerged in an aquatic environment up to 300 meters below surface, and still collect a water sample 24 from the environment outside the device. A fully loaded instrument with cartridges and analytic modules 26 may be deployed as a payload on a 12″ diameter scale autonomous underwater vehicle (AUV) 28; a fleet of such vehicles would allow fully automated, coordinated and synoptic in situ sampling at multiple sites.

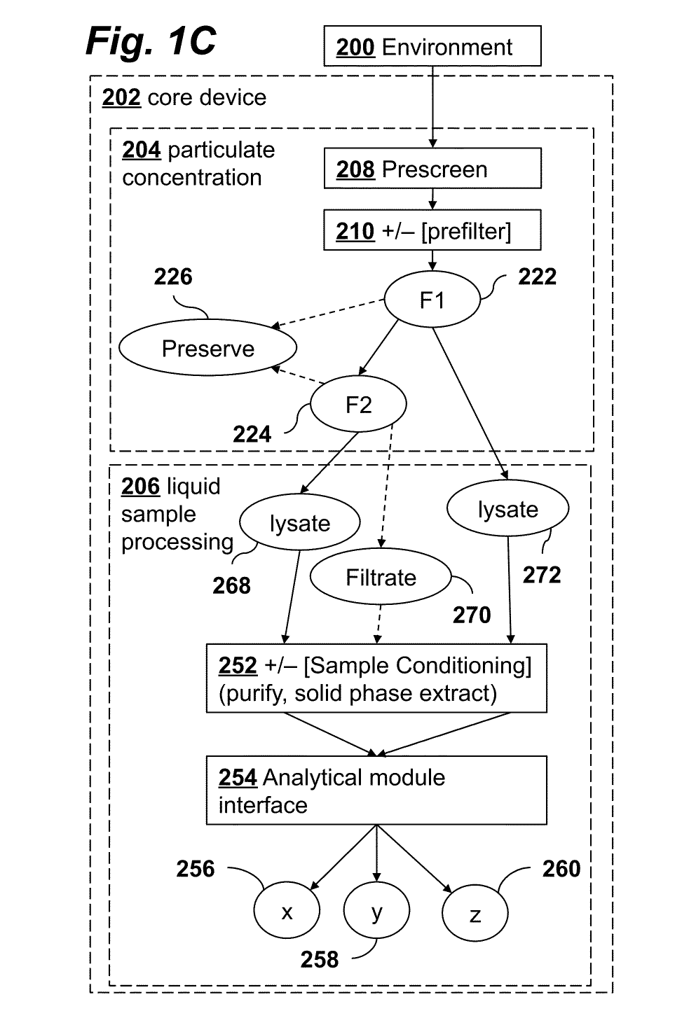

The compact size of this device is possible by using a cartridge-based system to effect sample collection and handling. As shown in FIG. 3, sampling and processing cartridges 30 are self-contained, single sample particle or substance concentrators and processors. A cartridge can be built from modular components, including collection media 32 (e.g., filter), fluid paths, valves, a variety of reagents, fluid reservoirs 34a-d, and flow management elements as needed to achieve the overall desired function. Cartridges also have a product port 64, supply port 102, and return port 114. Cartridge product treatment modules 31a, 31b can be added to cartridges to enable additional processing capabilities. Cartridges can also contain embedded electronics 36 for identification, control logic for elements such as heaters, tracking device history, and for recording its use along with corresponding meta data. The cartridges use forced motion, electrical power, and higher-level control instructions from the core actuation instrument. Each cartridge is intended to be operated only once per deployment, eliminating much of the flushing and decontamination systems necessary on previous instruments.

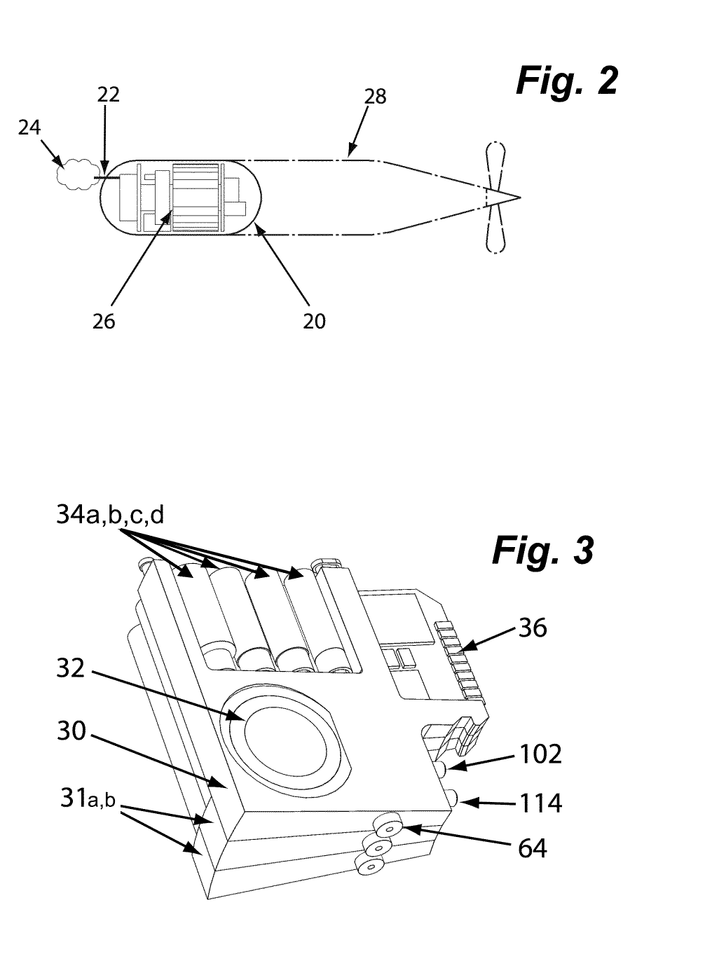

Another unique feature of this instrument is the configurable sample flow path 37, shown in FIGS. 4A, 4B that can deliver source fluid in various configurable ways to one or more cartridges 38a-b during a single sampling event. As illustrated in FIG. 4A, by appropriate control of valves 39a-c multiple cartridges 38a-b can receive the source fluid in serial path during the same sampling event. Alternatively, as illustrated in FIG. 4B, by appropriate control of valves 39a-c multiple cartridges 38a-b can receive the source fluid in parallel paths during the same sampling event. By appropriate control of valves of other cartridges, combinations of parallel and serial paths are simultaneously possible as well. This capability allows the instrument to perform all three use-cases as described above, in order to provide replicates or size fractionated samples as specified by the user.

### Instrument

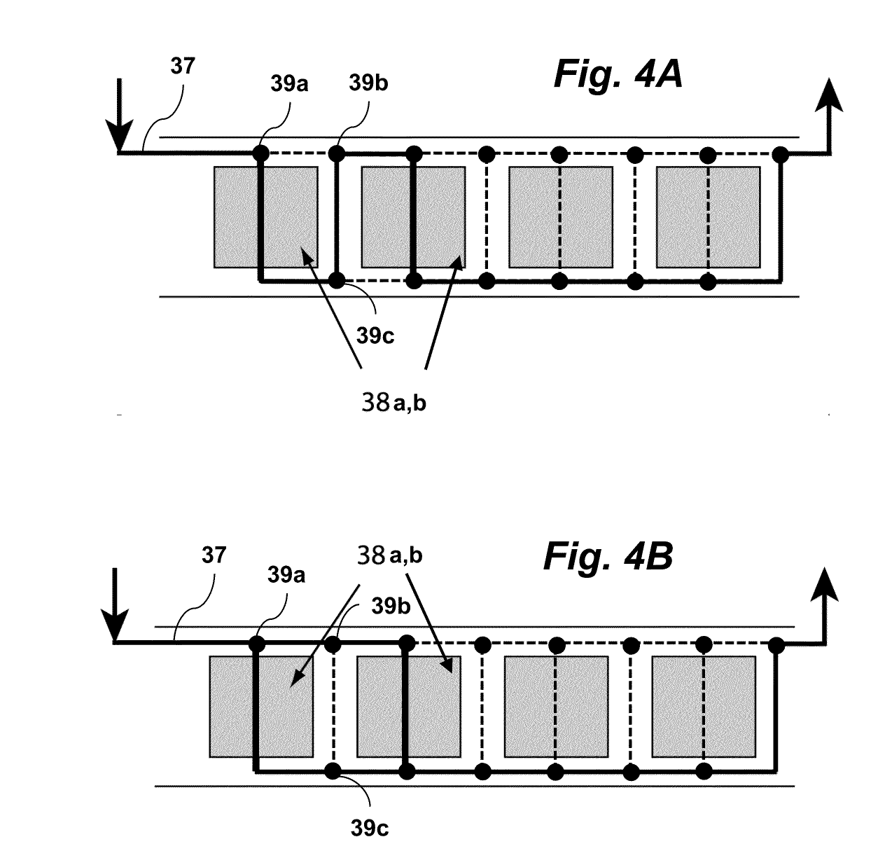

In the embodiment shown in FIG. 5, the core of the device includes a cartridge actuation machine including higher-level control electronics 40a-c, sample source isolation valves 42a-b, sample pumping system 44, pressure sensors 46, a rotatable cartridge wheel 48, and cartridge actuation mechanism (only one shown) 66. Multiple cartridges 30 can be loaded into the wheel around a central ring of distribution valves 54 with a valve actuator 56. Cartridge supply port 102, and return port 114 interface with the distribution ring valves. The sampling pump(s) 44 are in an oil reservoir, pressure balanced to the source fluid so the system only needs to generate the differential pressure required for filtering, not the total pipeline or ambient environment pressure. The cartridge wheel can be rotated by a position-controlled motor 58 to place a cartridge into the processing position 60 where the cartridge actuators 66 and the hand-off coupler 62 align with the cartridge syringes and cartridge product port 64.

At the processing position 60 the instrument has several linear cartridge actuators 66, with twin lead screws 68 driven by a cartridge actuator stepper motor 70 and linked by a gear train. The lead screws turn in the same direction, at the same speed, so the attached rider bar 72 produces linear motion parallel to the cartridge actuator support plate 74. Each rider bar is connected to a push rod 76 that extends through the cartridge wheel 48 and into the cartridge and typically moves cartridge components such as reservoir fluid manipulation plungers 118, or cartridge valve 88.

The processing position also aligns the cartridge product port 64 with the hand-off coupling 62 and homogenate hand-off system 78 that can direct cartridge products to waste storage 80 or an attached analytical module 82. The interface between the sampler and the analytic modules includes a defined power/fluid/communications standard that allows for “plug and work” interoperability.

### Cartridges

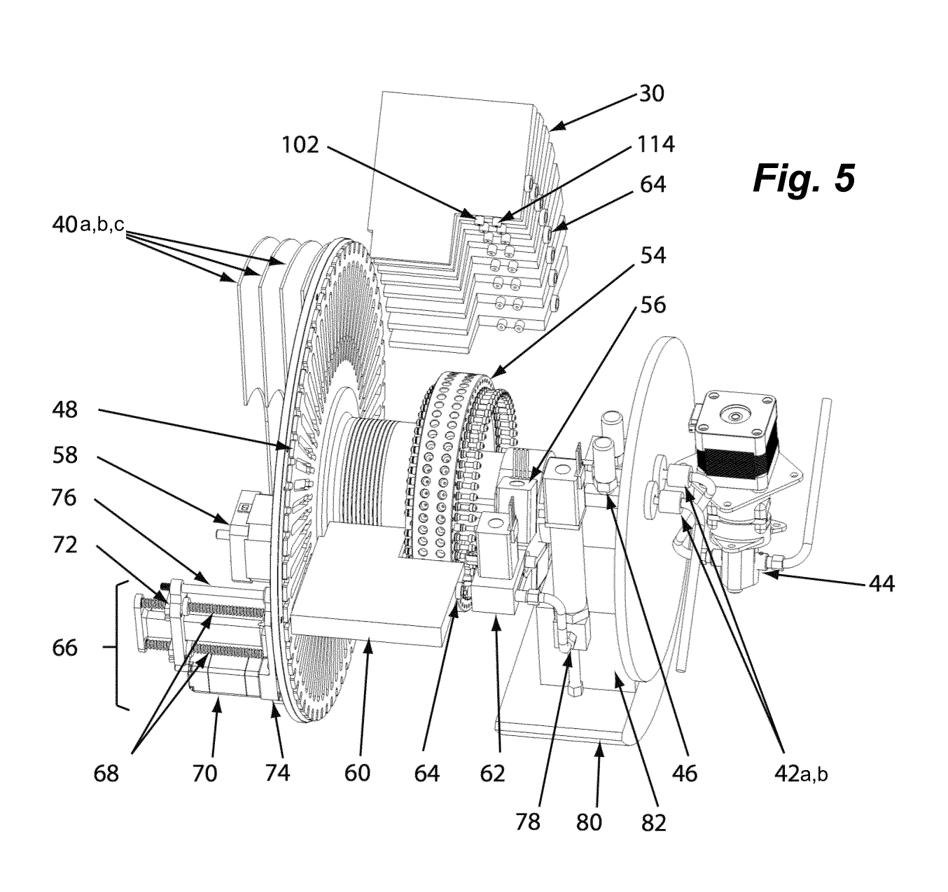

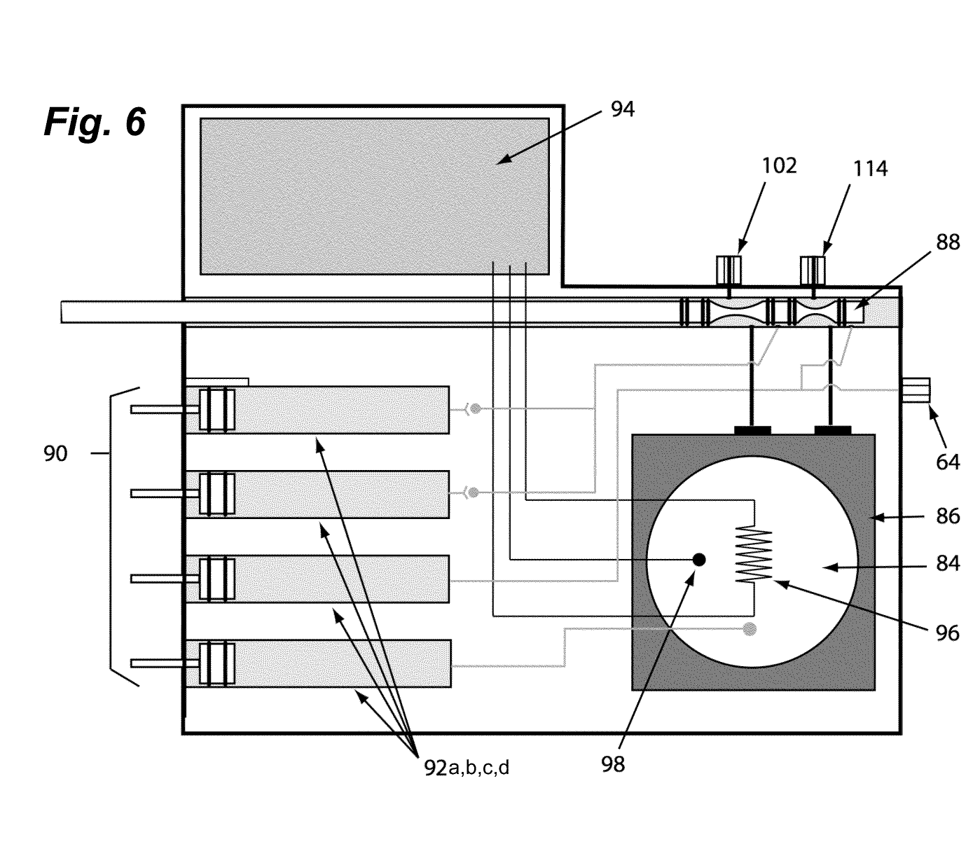

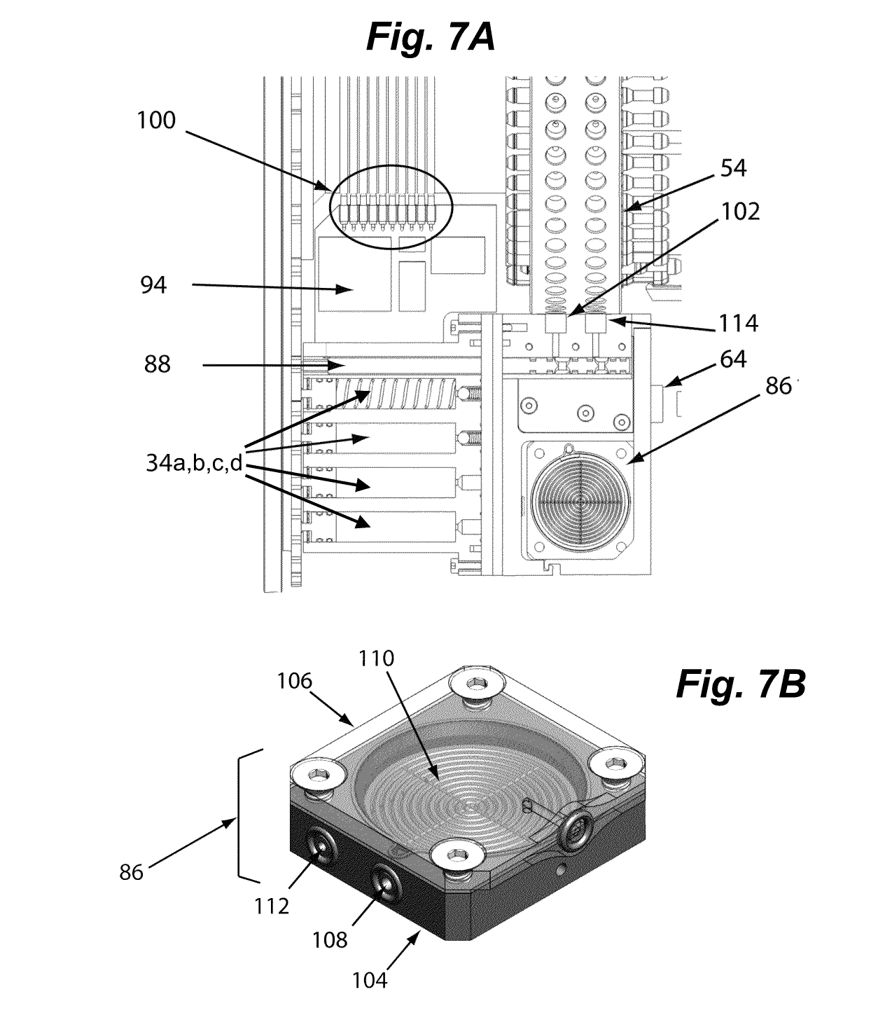

The sampling cartridges are configurable components of the sample collection and processing device. An embodiment of a cartridge will now be described in relation to FIG. 6, FIGS. 7A-B. The cartridge is configured to be used for concentrating and manipulating particles; it includes a collection filter 84, filter holder 86, valves 88, fluid manipulators 90, reservoirs containing processing reagents 92, control electronics 94, heater 96, and media temperature sensor 98 used to preserve and/or homogenize the collected material.

When loaded onto the core instrument, the cartridges make electrical connections to a common electronics bus 100 linking cartridges to the main instrument, and fluid connections to the ring valves 54 that control the flow path through the cartridges (FIGS. 4A, 4B). Electronics 94 onboard each cartridge include information that identifies the cartridge, provides processing instructions, and records device history as well as a sample processing log.

The cartridge valve 88 controls whether fluid moves through a sampling loop or reagent loop within the cartridge. In the sampling position fluid enters the cartridge at the supply port 102. It then flows through a flow path around the cartridge valve 88 to a reloadable collection media (filter or chemical sorbent) holder 86. This holder includes a base 104 with a ridged surface that holds sample collection media, and a top cover 106. The source fluid enters the collection media holder intake port 108, fills the space above the sample collection media, passes through that concentrator into grooved flow channels 110 in collection media holder base and exits to exhaust port 112. There, the fluid follows another path around the cartridge valve 88, and leaves the cartridge through the return port 114.

When the cartridge valve 88 is in the reagent position, fluid moves between reservoirs 34a-d and the collection media holder 86; cartridge sample supply port 102 and return ports 114 are blocked.

A cartridge may be configured for a single, basic process (such as sample preservation), or it may contain additional components to support a number of more complex, multi-step sample processing methods (e.g., sample extraction and fractionation). Functionality of a given cartridge is realized by combining various sub-assemblies from a set of commonly used components. A cartridge may also be coupled with additional cartridges to provide extended functionality, or to perform a cascade of treatments to sample derivatives or material collected from the primary filtrate.

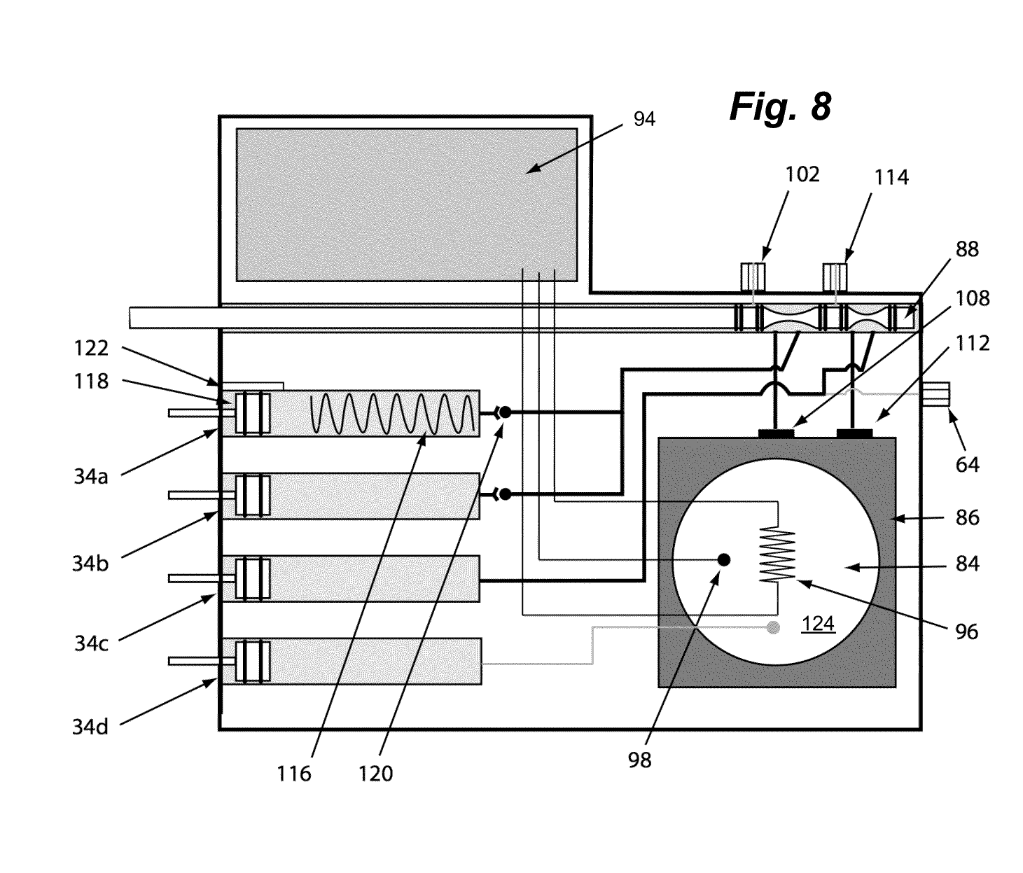

In the embodiment of the cartridge shown in FIG. 8, the cartridge valve 88 is in the reagent position. Reservoirs 34a-d are ordered starting nearest the cartridge valve 88. Channels connect two reservoirs 34a, 34b to the sample collection media holder intake port 108. Reservoir 34a contains air, and is used to clear excess fluid from the collection media holder between processing steps. Reservoir 34a may be assembled with a plunger return spring 116 to assist the return of the plunger 118 to the top of the reservoir, and a spring-ball check valve 120 that permits contents to exit the reservoir but not return. Near the top of this reservoir is an air replenishment groove 122 that allows refill of the reservoir with ambient air. In this embodiment, reservoir 34a can be operated more than once to pump additional air into the filter holder. Reservoir 34b contains a reagent for preserving or processing the collected sample. With the cartridge valve in the reagent position and the cartridge product port 64 blocked, channels connect reservoir 34c to the collection media holder exhaust port 112. This reservoir may be used to collect waste fluids from the collection media holder as the cartridge is processed, or may be used to collect material eluted from the sample collection media and, if needed, mix that fluid with modifying reagents prior to off-loading conditioned sample out the cartridge product port 64. In this embodiment, reservoir 34d is connected to a flexible diaphragm housed in the sample collection media holder top 124. Actuation of the plunger in reservoir 34d is used to expand the diaphragm into the holder to physically displace fluids out of the holder.

### Operation

### Preferred Embodiment

### Sample Collection

Sample collection by the instrument constitutes concentrating particulates or dissolved material from the source fluid onto collection media contained in one or more cartridges. When both intake and exhaust bulkhead valves 42a-b (FIG. 5) are open to the outside environment, a fluidic path is enabled through the instrument. A pressure balanced pumping device 44 moves the source fluid from outside the device, through a central ring of multiple, 2-position valves 54. The central ring valve actuator mechanism 56 can select and position any ring array valve. In position one, a valve will direct the fluid on to the next valve, or in position two, the valve will direct the source fluid out of a supply port 102 and through the attached cartridge 30. In the cartridge, the fluid passes through the collection media where particulates and/or dissolved substances are concentrated. The material retained on the collection media is a “sample” that can subsequently be processed. The source fluid exits the cartridge via a return port 114, where it continues through the flow loop around the valve ring. Fluid passing from a cartridge may be passed over additional collection media contained in another cartridge(s) 30 downstream on the valve ring to concentrate other material that can also be subjected to further preservation or processing. The source fluid is returned to the environment once it completes its passage through the ring valve.

### Sample Processing

Processing of the sample is performed by the instrument actuating the cartridge in a manner that either preserves and stores the collected material for later analysis, or liberates components for immediate analysis via one or more attached analytical modules. In both cases, the procedure begins with the cartridge wheel rotation motor 58 turning the cartridge wheel 48 to the “processing position” 60; at this station a cartridge is aligned with the cartridge actuators 66.

### Sample Preservation

At the cartridge processing position, the cartridge valve actuator 66 directs the cartridge valve 88 so that the fluid path is directed from the sampling to processing position as described above. A cartridge syringe actuator 66 pushes the plunger 118 (FIG. 8) of the preservation syringe 34b, delivering the preservation reagent into the collection media holder 86, saturating the media 84 with preservative. The residual fluid in the collection media holder left over from the initial sample collection event exits the holder from port 112 and is captured in the cartridge waste reservoir 34c. After an appropriate time, if needed, the cartridge actuator cycles the air syringe 34a one or more times, to displace residual preservative through the collection media 84, out the collection media holder exhaust port 112 and into the waste reservoir 34c. Check valves 120 on the preservative and air syringes prevent back flow of fluid or air. At this point sample material is stabilized, and all actuators 66 (FIG. 5) are withdrawn from the cartridge so that the cartridge wheel 48 is free to rotate, allowing processing of another cartridge 30.

### Sample Processing

Processing of a sample for immediate analysis starts with the hand-off coupling 62 (FIG. 5) joining to the cartridge product port 64, connecting it to the cartridge product hand-off system 78 having pump and valves. As above, the cartridge valve actuator 66 switches the cartridge valve 88 (FIG. 8) from the sampling position to the reagent position, creating a flow path from the cartridge reservoirs 90 (FIG. 6) to the sample collection media holder 86 (FIG. 8). A valve of the product hand-off system 78 (FIG. 5) changes position so that the cartridge product port is connected to a waste container 80. Then the cartridge syringe actuator 66 pushes the plunger of the diaphragm syringe 34d (FIG. 8), delivering an inert fluid into the space between the diaphragm and the filter holder top 106 (FIG. 7B). The bulging diaphragm displaces residual fluids from the collection media holder 86 (FIG. 5) and out of the cartridge where it flows to waste 80. A valve of the hand-off system 78 then closes, effectively sealing the cartridge product port 64.

A chemical or biological reagent may be added to the collection media holder by a coordinated move of the cartridge actuator pushing the plunger of reservoir 34b (FIG. 8), injecting a prescribed volume of that fluid into the holder 86, as the plunger in reservoir 34d withdraws an equal amount releasing the diaphragm from the collection media surface. If the sample processing procedure uses heating, the cartridge controller 94 receives directions from the core controller 40a-c (FIG. 5), and adjusts the temperature accordingly via the attached heater 96 (FIG. 8) in concert with feedback from an embedded temperature sensor 98. After a prescribed period of time, the core controller directs the cartridge controller 94 to stop heating. At that point, the fluid within the collection media holder is known as a “homogenate”; it is comprised of cellular components, organic and/or inorganic molecules.

The homogenate is delivered to an attached analytical module 82 (FIG. 5) by the hand-off valve changing positions so that the cartridge product port 64 is connected to the intended downstream device. The cartridge syringe actuator 66 pushes the plunger of the diaphragm syringe 34d, displacing homogenate from the collection media holder, out the cartridge, to the intended analytical module. To continue moving homogenate, the plunger in reservoir 34d is held in the depressed position. Then the plunger in reservoir 34c injects an additional volume of fluid or gas to move the product further from the cartridge product port 64 so that the analytical module receives the required portion of homogenate.

At this point the processing cartridge actions are completed. The hand off valve 78 (FIG. 5) is closed to the cartridge. The hand-off coupler 62 disconnects from the cartridge product port 64. All the cartridge actuators are withdrawn from the cartridge 66, so that the cartridge wheel 48 is free to rotate and move another cartridge into the processing position 60. The analytical module completes the analysis of the delivered homogenate, and communicates the resulting data to the core instrument controllers 40a-c.

### Description and Operation

### Alternate Embodiments

Alternate embodiments to the above device include two general categories. The first relates to changes within the cartridge design, where different syringe order actuation or different fluid connections within the body of the cartridge would result in alternate fluid movements. For instance, reservoir 34a could have the return spring 116 removed and hold liquid rather than air. Any combination of the reservoirs 34a-d might exit though ball-spring check valves 120, depending on the fluidic movement requirements. Additionally, changes in the fluidic paths of a cartridge may allow waste storage onboard within previously empty reservoirs. Storing waste onboard would simplify fluid handling and obviate the need for the cartridge product exit port 64 and the resulting downstream fluid path hand-off coupler, hand-off system, and waste storage 62, 78, and 80, respectively.

In addition to these fluidic changes, cartridges could hold modified sample concentration material, for example as pleated or tubular rolls, rather than the flat disc described above. With appropriate adjustments in the fluidic path(s) within the cartridge body, these alternative media forms would permit multiple collection events per cartridge akin to what is outlined in FIGS. 1B-C.

Another embodiment concerns the device housing. The description here focuses on inclusion within an AUV, but this device could be housed in any container: it could be hand-carried within a custom case, mounted on a laboratory bench, or at a fixed location in or out of water (e.g., on a pier, on a mooring, at a well head, in a product stream flow path, etc.) using a housing appropriate for the work environment.

### CONCLUSION

New ways of analyzing organic and inorganic materials have exploded in recent years. The power of these new analytical methods for environmental research and monitoring is truly astounding—it has led to the discovery of organisms new to science, helped to reveal the underpinnings of elemental cycling that sustains all life on Earth, pointed to key indicators for assessing impacts associated with global change, fueled the idea of “bio-prospecting”, and helped speed the detection of species that are toxic or harmful to humans and wildlife. These advancements have profound implications for use in environmental research, resource management, agriculture, product stream quality assurance, and public health safety. However, one of the long-standing challenges common to all of these applications is acquiring and handling samples in preparation for testing. The instrument described here is designed to alleviate that roadblock by automating liquid sample collection and processing in a manner that will operate for extended periods outside of a laboratory, and that will support a variety of “back end” detection systems. Users may remotely communicate with this device via direct connection, wireless acoustic or radio transceivers, or a combination of systems such as the Internet, cellular, satellite, relay acoustic buoys, and submerged acoustic transceivers that link together to allow the user to access the data produced by this instrument and other platform sensors in near real-time, or during subsequent communication windows. Users may also use this communication to remotely update the mission parameters held in software to redirect the instrument mobile platform, adjust sample collection trigger parameters, and sample processing methods as needed in response to changing conditions observed by this instrument or other monitoring assets. This capability offers a wide range of applications such as monitoring marine or freshwater environments, agriculture sites, and industrial product streams. Its utility is further enhanced because it can be deployed in a network configuration to coordinate assessments of biological and chemical properties over extended geographic areas absent direct human intervention. Integrated instruments that allow for autonomous, in situ sample collection and detection of organisms and other substances found in the environment are being developed, but currently are bulky, expensive, and require substantial infrastructure in order to deploy for any appreciable length of time.

This invention overcomes that problem of size and complexity by utilizing a novel cartridge design that includes on-board reagents, valves, and electronics. When combined with a common sample pumping and actuation device, these configurable and compact cartridges allow users to execute a variety of sample collection and preparation protocols remotely. The self-contained nature of each cartridge and the small size of the sampling and actuation instrument will permit its use on autonomous underwater vehicles, and lead to the development of portable, hand-carried instruments for water quality or product stream monitoring. This capability will significantly reduce the need for routinely transporting samples from the field to a laboratory. Reducing the time and labor to perform analyses and interpret results will improve our understanding of a host of environmental issues and thus improve decision-making.

1. A flow-through water collection and processing device comprising:
an intake valve configured to controllably allow water to flow into the device from an environment external to the device;
an exhaust valve configured to controllably allow water to flow out of the device into the environment;
a fluidic path through the instrument from the intake valve to the exhaust valve;
a pumping system configured to pump water through the fluidic path;
a central ring of distribution valves configured to controllably select simultaneous parallel flow paths of the fluidic path;
multiple removable flow-through sampling cartridges positioned in the simultaneous parallel flow paths and configured to allow water flowing through the flow paths to flow through the cartridges;
wherein each of the cartridges comprises an input port, an output port, a cartridge flow path from the input port to the output port, and a sample collection medium configured to collect material suspended or dissolved in the water flowing through the flow path;
and
control electronics configured to turn on and off the pumping system, and to open and close the intake valve, exhaust valve, and distribution valves.

2. The water collection and processing device of claim 1,
wherein two or more of the multiple sampling cartridges are positioned in at least one of the simultaneous parallel flow paths, whereby water flows in series through the two or more of the multiple sampling cartridges.

3. The water collection and processing device of claim 1, further comprising:
a rotatable cartridge wheel configured to hold the cartridges, and a motor configured to rotate the wheel.

4. The water collection and processing device of claim 1, further comprising:
an analytical module configured to process the material collected in at least one of the cartridges.

5. The water collection and processing device of claim 1, further comprising:
a cartridge product hand-off system configured to deliver collected material from one of the sampling cartridges to the analytical module.

6. The water collection and processing device of claim 1, further comprising:
an electronic bus configured to make electrical contact with cartridges.

7. The water collection and processing device of claim 1,
wherein each cartridge further comprises:
on-board electronics, processing reagents, heater, fluid reservoirs, fluid manipulators, flow management elements, and sensors.

8. The water collection and processing device of claim 1,
wherein each cartridge further comprises:
on-board electronics configured to store information that identifies the cartridge, to provide processing instructions, and to record a processing log.

9. The water collection and processing device of claim 1,
wherein each cartridge further comprises:
a cartridge product treatment module configured to perform material processing.
